(19) United States
(12) Patent Application Publication
(10) Pub. No.: US 2009/0218787 A1
(43) Pub. Date: Sep. 3, 2009

(54) PROTECTIVE AND DECORATIVE FAUX VEHICLE BUMPER COMPONENT

(76) Inventors: Wallace R. Jones, Green Cove Springs, FL (US); David A. Higley, Akron, OH (US)

Correspondence Address: Fay Sharpe LLP, 1228 Euclid Avenue, 5th Floor, The Halle Building, Cleveland, OH, 44115, US

(21) Appl. No.: 12/393,406

(22) Filed: Feb. 26, 2009

Related U.S. Application Data
(63) Continuation-in-part of application No. 11/891,413, filed on Aug. 10, 2007.
(60) Provisional application No. 60/837,082, filed on Aug. 11, 2006.

(51) Int. Cl. B60D 1/14

(52) U.S. Cl. 280/491.5

(57) ABSTRACT

A faux vehicle bumper component includes an elongated body panel having a pair of receivers or connectors at spaced apart locations therealong adapted to engage a pair of spikes or prongs from a tow bar connecting system protruding generally from the grill area of an associated vehicle to be towed. The receivers or connectors are adjustably secured to the body panel in order to accommodate different or varied spacings of the spikes or prongs and/or different types and styles of vehicles. Releasable fasteners are used for selectively securing the associated spikes or prongs to the receivers or connectors. Installation of the faux bumper component eliminates a potentially hazardous condition that exists when the spikes or prongs are exposed during a non towed condition of the vehicle.

### CROSS-REFERENCE TO RELATED APPLICATIONS

This application is a continuation-in-part of U.S. application Ser. No. 11/891,413 filed Aug. 10, 2007, which claims priority from and benefit of the filing date of U.S. provisional patent application Ser. No. 60/837,082 filed Aug. 11, 2006 (Aug. 11, 2006), and the entire disclosures of said application Ser. No. 11/891,413 and said provisional application Ser. No. 60/837,082 are hereby expressly incorporated by reference into the present specification.

### BACKGROUND OF THE DEVELOPMENT

This development relates to vehicle tow bar assemblies and, more particularly, to tow bar assemblies or systems that facilitate so-called “four wheels down” towing. The development is particularly suited for towing an automobile type vehicle behind a self contained or bus type camper or coach and will be described with reference thereto. However, the development can also be used for similar applications in related environments.

Self contained camper units, coaches or buses are becoming quite popular with families and the like who travel the country for business and/or pleasure. Oftentimes, these units are rather large and cumbersome and difficult to drive or otherwise maneuver in cities or other urban areas. The camper units are typically parked in campgrounds or other designated areas where, once parked, they are difficult or inconvenient to move if the owner for some reason wants or needs drive to an area some distance from the parked unit.

As a result of the foregoing circumstances, many people have commenced to tow regular automobiles behind their camper units in order to have the flexibility of taking side trips or other travel once the camper units have been parked in a camper parking area. While towing vehicles is itself well known, the so-called four wheels down type of towing arrangement is becoming quite popular in this environment. In this type of towing arrangement, a tow bar extends outwardly from the rear of the camper unit and is secured by releasable means to the towed vehicle so that all four wheels of the towed vehicle ride on the road surface during towing.

Tow bar systems for accommodating four wheels down towing are known in the industry and typically require a special tow bar connection to be installed on the vehicle to be towed. The tow bar connection requires some modification to or removal of a portion of the vehicle grill. In existing arrangements, the tow bar connection is such that a pair of spaced apart elongated prongs or spikes extend outwardly from the vehicle grill and/or bumper area generally parallel to and on opposite sides of the vehicle longitudinal axis. These prongs or spikes, in turn, are received by spaced apart receivers disposed on the rear of the tow bar itself. Locking pin arrangements are then used to interconnect the tow bar and prongs in order that the vehicle can be safely towed behind the camper unit. When the camper is parked and it is desired to use the towed vehicle, it is simply necessary to remove the locking pins to release the vehicle from its connected condition to the camper unit.

While the foregoing type of towing arrangement is finding success, some problems and issues have been noted. First, it is typically necessary to remove or alter at least a portion of the vehicle grill to facilitate installation of the special tow bar connection. This, in turn, leaves an unsightly appearance to the vehicle when it is separately or independently driven. Second, the spikes or prongs extend outwardly from the vehicle grill area and thus create a safety hazard. That is, the spikes or prongs are most generally located at or slightly below knee level and create a potential hazard to persons walking by the front of the vehicle when it is parked. Such potential is particularly acute in the night season when the spikes or prongs are much more difficult to observe to an unwary pedestrian. In an effort to help alleviate this problem, some people have taken to cutting slits in tennis balls, and then inserting such a tennis ball over the outwardly protruding end of each of the spikes or prongs. This, at best, is deemed to be only a temporary fix, and the tennis balls may fall off during driving or otherwise. Moreover, this approach creates an unsightly condition on the vehicle. While it is possible to remove the entire tow bar connection or the spikes or prongs from the vehicle when not in use, such removal can be both time consuming and difficult.

Many of the four wheels down installations also include an additional air connection terminal which similarly protrudes outwardly from the grill area of the towed vehicle intermediate the spikes or prongs. This air connection facilitates operation of the brakes of the towed vehicle as is known and presents another unsightly appearance and safety hazard. Still further, installation of the tow bar connection oftentimes necessitates removal of the front license plate mounting bracket. Many states mandate that both front and rear license plates be displayed, so the front license plate must then be displayed in the front window or some other available area at the front of the automobile. This is both cumbersome and unsightly.

The subject new development is deemed to address and overcome the foregoing issues and problems, and provides a new protective and decorative faux vehicle bumper component which readily accommodates four wheels down types of vehicle towing systems.

### SUMMARY

In accordance with one aspect of the present development, a protective and decorative faux bumper component is adapted for selective installation on a tow bar connecting assembly of the type having a pair of outwardly protruding laterally spaced apart connecting prongs. The bumper component includes: an elongated main panel having opposed end sections extending generally outward from a panel center section; a prong connector secured to each of the panel end sections and having a prong receiver at an area thereof. Axes of the prong receivers are disposed generally parallel to each other and generally transverse to a longitudinal axis of the main panel extending between the opposed end sections. The prong receivers are adapted to retainingly communicate with the connecting prongs of an associated tow bar connecting assembly.

In accordance with another aspect of the present development, a protective and decorative faux bumper component is adapted for selective connection to a tow bar connecting assembly having a pair of outwardly protruding connecting prongs. The bumper component includes: an elongated main panel having a longitudinal axis extending between opposed panel ends disposed outwardly of a panel center section; at least one elongated through slot in each of the panel opposed ends; a prong connector secured to the main panel through the at least one slot at each of the panel ends; and, a prong receiver included in each prong connector. The prong receivers have axes disposed generally parallel to each other and generally transverse to the main panel longitudinal axis. The bumper component further includes first retainers for securing the prong connectors to the main panel through the slots and allowing selective adjustment of one of the transverse distance between said prong connectors and the lateral distance between said prong connectors and said main panel longitudinal axis.

In accordance with another aspect of the present development, a protective bumper device includes first and second connectors adapted for respective releasable engagement with first and second protruding prongs of an associated vehicle tow bar connecting assembly. The protective bumper device further includes a body connected to and extending between the first and second connectors, the body adapted to cover at least part of the first and second prongs with which the first and second connectors are engaged.

### BRIEF DESCRIPTION OF THE DRAWINGS

The development may take form in certain parts and arrangements of parts, preferred and alternative embodiments of which will be described in detail in this specification and illustrated in the accompanying drawings which form a part hereof and wherein:

FIG. 1 is a perspective view of an automobile with a four wheels down type of hitch or tow connection secured thereto;

FIG. 2 is an exploded perspective view of a preferred embodiment of the subject development;

FIG. 3 is an enlarged exploded perspective view of a spike or prong connector assembly formed in accordance with the subject development;

FIG. 4 is a perspective view of the development in the installed condition on an automobile;

FIG. 5 is a perspective view similar to FIG. 2 showing an alternative embodiment of the subject development;

FIG. 6 is an enlarged perspective view similar to FIG. 3 for showing the prong connector assembly formed in accordance with this alternative embodiment;

FIG. 7 is a front elevational view of another alternative embodiment of the development;

FIG. 8 is a perspective view similar to FIG. 2 showing another alternative embodiment of the development; and,

FIG. 9 is a perspective view similar to FIG. 2 showing still another alternative embodiment of the development.

### DETAILED DESCRIPTION OF PREFERRED AND ALTERNATIVE EMBODIMENTS

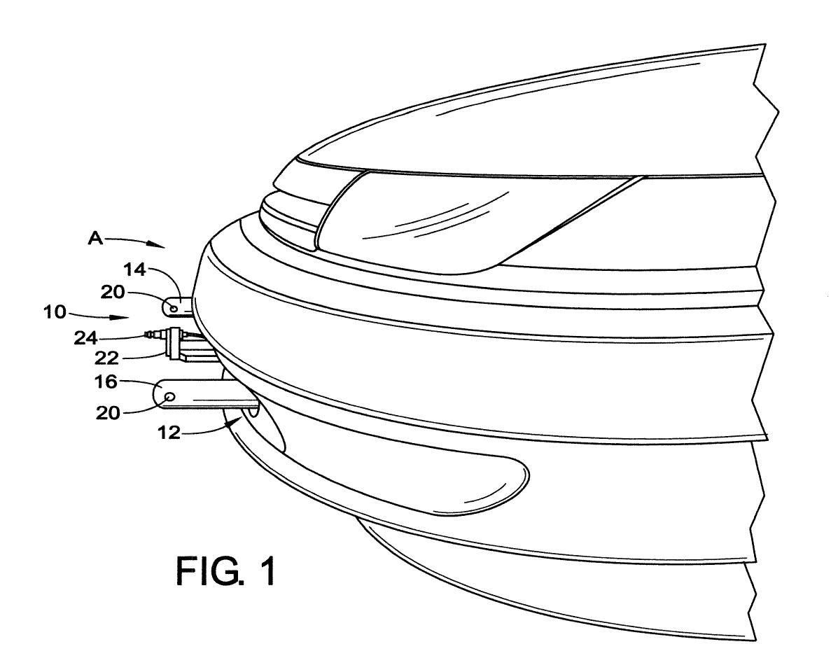

Referring now to the drawings wherein the showings are for purposes of illustrating preferred and alternative embodiments of the development only and not for purposes of limiting same, FIG. 1 shows the forward end of a conventional automobile type vehicle A. A tow bar connecting assembly 10 protrudes outwardly from an opening 12 in the conventional grill and/or bumper area of the automobile. Normally, the grill area may have to be modified at least slightly to create opening 12 as is known in order to accommodate tow bar connecting assembly 10. The construction of the connecting assembly itself is generally known and includes a pair of spaced apart spikes or prongs 14, 16 fixedly secured to the automobile so as to protrude outwardly from the grill area generally parallel to and transversely spaced apart on opposite sides of the automobile centerline.

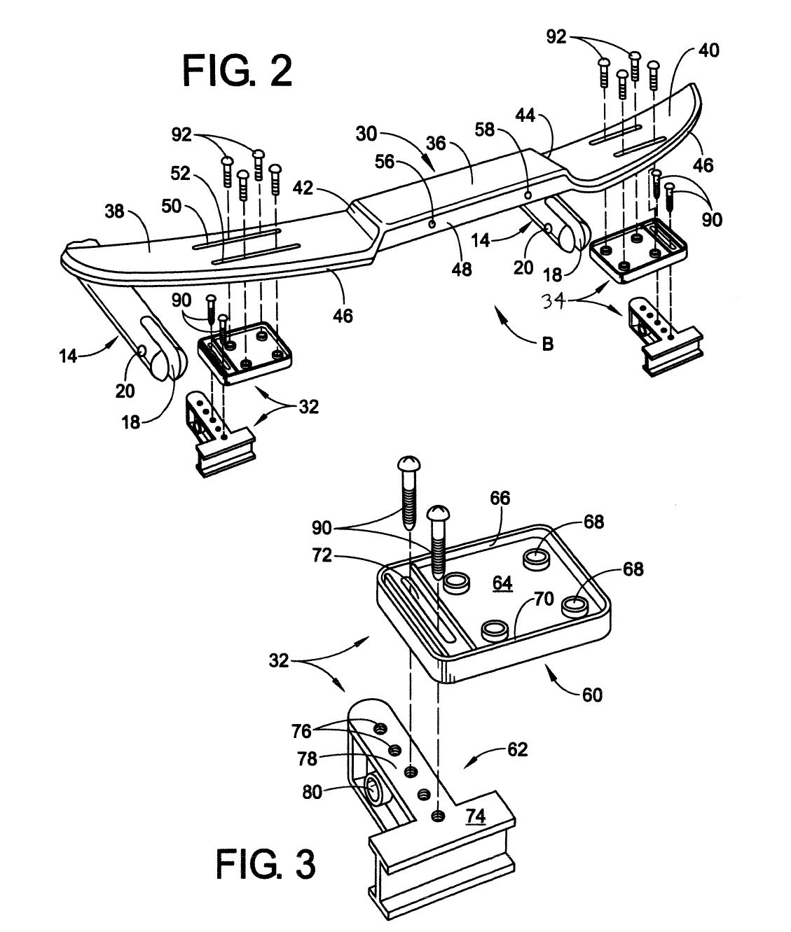

The spikes or prongs are most often removably secured to tow bar connecting assembly 10 in a known manner (not shown) wholly sufficient to allow towing of the automobile. The spikes or prongs 14, 16 are constructed from a strong metal such as steel or metal alloy and have a generally cylindrical conformation with a somewhat blunt or rounded outer end as is shown in FIG. 1. A slot 18 (FIG. 2) extends axially inward from the blunt outer end of each of prongs 14, 16 to facilitate installation of the subject faux bumper to an associated vehicle. A locking pin receiving opening 20 is included in each spike or prong adjacent the outer end thereof. Conventional locking pins are removably receivable through these openings for attaching a tow bar (not shown) to the tow bar connecting assembly.

In addition, an air cylinder assembly 22 is sometimes also mounted to the tow bar connecting assembly in such manner that it similarly protrudes outwardly from automobile grill opening 12. This cylinder includes a fitting or coupling 24 to accept an air supply hose running from the camper unit itself in order to facilitate operation of the automobile brakes during towing.

Because spikes or prongs 14, 16 protrude outwardly from the grill area at approximately knee height or so, they present a hazardous situation when the automobile is not connected to the tow vehicle and is being driven around in public areas. When cylinder assembly 22 is used, it, too, presents a potentially hazardous condition. Moreover, since it may be necessary to remove a portion of the automobile grill in order to successfully mount the tow bar connecting assembly to the automobile, removal of the front license plate bracket is most often required. This presents some issues in those states which require display of both front and rear license plates on vehicles registered in those states.

In an effort to reduce the hazardous potential presented by the outwardly protruding spikes or prongs, as well as the cylinder in those installations where it is used, some people have taken to slitting tennis balls and then slipping them over the outermost ends of the protruding components. This presents an unsightly appearance, and simple driving of automobile A may dislodge the balls from their protective positions, thus re-exposing the hazardous elements of the spikes and cylinder.

As best shown in FIGS. 2 through 4, the subject new development advantageously provides a protective and decorative faux vehicle bumper component or unit generally designated B. This device is comprised of an elongated generally flat panel or body 30 and a pair of spaced apart prong receiver or connector assemblies 32, 34. The panel or body 30 has a central area 36 with opposed ends or wings 38, 40 extending oppositely outward therefrom at wall areas 42, 44, respectively. Each of opposed ends or wings 38, 40 includes a downwardly depending or extending flange area 46 extending along at least the front edge thereof. In like manner, central area 36 includes a slightly recessed flange area 48 depending therefrom. It is to be noted that the front edges of ends or wings 38, 40 have a generally arcuate or otherwise convexly curved conformation from their connections with central portion 36 to their outermost ends. This conformation is highly desirable for reasons to be described hereinbelow.

A pair of elongated slots 50, 52 extend through the surface of each of ends or wings 38, 40 for mounting and adjustment purposes as will be described. These slots are located so that when the device is installed on an automobile, the slots are disposed to run transversely of the automobile longitudinal axis and the spikes or prongs protruding from the vehicle grill area. In addition, fastener openings 56, 58 penetrate flange area 48 and are appropriately spaced apart from each other to facilitate securing a license plate and/or a license plate holder frame thereto.

The protective and decorative faux vehicle bumper component or unit B is preferably molded from a suitable plastic material or resin which has some flexibility and is capable of absorbing some shocks or loading as may be encountered in a vehicle driving type of environment. Depending upon the specific application of unit B, different types of plastics or resins may be preferred. Flange areas 46, 48 and walls 42, 44 provide structural strength to unit B but will allow for some bending or flexing to accommodate some loading during use.

Continuing with reference to FIGS. 2 and 3, prong receivers or connectors 32 and 34 are virtually identical. Accordingly, description will hereafter be made to prong receiver 32, it being appreciated that receiver 34 is identical thereto.

FIG. 3 in particular shows receiver 32 as comprised of a generally square or rectangular intermediate plate or plane 60 and a lower or vertical slot or clevis adaptor 62. Plate or plane 60 has a generally flat base or body 64 with a peripheral flange 66 protruding at least upwardly therefrom. A plurality of screw receiving protrusions or pedestals 68 extend at least upwardly from base or body 64, and each includes a threaded fastener receiving opening 70 extending thereinto for reasons and purposes to be described. Four such openings are used in the preferred embodiment and they are positioned to align with slots 50, 52 in wings 38, 40 of body 30 for reasons that will become apparent hereinafter. An elongated through slot 72 is disposed adjacent one side edge of the intermediate plate 60 from adjacent the front face toward the rear face thereof. The purpose of slot 72 will likewise be described hereinbelow.

Lower or vertical slot or clevis adaptor 62 has a generally T-shaped overall conformation with a cross section which is similar to an I-beam. However, many other conformations may also be satisfactorily employed within the spirit and scope of the subject development. A planer upper surface 74 of this adaptor includes a plurality of threaded fastener receiving openings 76 extending thereinto along leg 78 which defines a tang or extension/projection for mounting purposes in a manner to be described. A reinforced pin receiving opening 80 extends through leg 78 transversely of openings 76 for likewise mounting the faux grill B to an associated vehicle A in a manner to be described.

Intermediate plate or plane 60 and lower or vertical slot or clevis adaptor 62 are preferably constructed or molded from a plastic material which has suitable strength and rigidity to retain the faux grill in a securely mounted position on an associated vehicle while allowing flexibility to absorb some impact. The specific type of material employed will be dictated to some extent by the particular application intended for the faux grill.

Referring now to all of FIGS. 1-4, description will be made to installation and use of the subject protective and decorative faux vehicle bumper component or unit B. Component B is adapted to conceal the outwardly protruding portions of tow bar connecting assembly 10 (FIG. 1) including the spikes or prongs 12, 14 as well as air cylinder 22 while providing a more aesthetically pleasing appearance to the automobile.

To that end, for each of connectors or receivers 32, 34, first retainers or threaded fasteners 90 are employed to first loosely connect plate or plane 60 to slot or clevis adaptor 62 via slot 72 and selected ones of openings 76 (FIG. 3). These components are then loosely secured to ends or wings 38, 40 of flat panel or body 30 by second retainers or threaded fasteners 92. These fasteners pass through slots or openings 50, 52 of body 30 and into openings 70 in base or body 64 of clevis adaptor 62. Components 60, 62 may then be manipulated in slots 50, 52 and 72, respectively, to secure the proper and desired alignment of the faux grill component or unit B with prongs 14, 16 of connecting assembly 10 on an associated automotive vehicle A. Once the desired alignment is achieved, fasteners 90, 92 may be tightened to secure the components in their desired fixed positions. While threaded fasteners 90, 92 are preferred, it is to be appreciated that other types of retaining or securing devices or systems may also be used to advantage within the spirit and scope of the development.

When properly aligned, legs 78 of prong receivers or connectors 32 and 34 are received in slots 18 of spikes or prongs 14, 16, respectively, so that through openings 80 align with openings 20 in the prongs. Unit B is then retained in position by means of conventional locking pins or the like (not shown) which are inserted through these aligned openings 80, 20. In fact, the locking pins may comprise the very same pins used for connecting tow bar connecting assembly 10 to the tow bar itself and, thus, are known. In addition, a strip of adhesive foam or gasket material (not shown) may advantageously be applied to a flange area depending from central area 36 of panel or body 30 opposite from flange area 48. This foam or gasket material will cushion the assembly and prevent noise or rattling between the vehicle and unit B under normal driving conditions.

The design and arrangement of the preferred embodiment here under discussion allows for selective adjustment of the transverse distance between legs 78 in connectors or receivers 32, 34 along slots 50, 52 (FIG. 2) of from a minimum of approximately 16.25 inches to a maximum of approximately 31.5 inches. Similarly, slots 72 in intermediate plates or planes 60 in combination with threaded openings 76 in legs 78 of slot or crevice adaptors 62 allow for a forward and aft adjustment of approximately 3.25 inches. Thus, the faux grill unit of the subject embodiment is readily adapted to effective use in a wide variety of different applications to accommodate a wide variety of different types of vehicles.

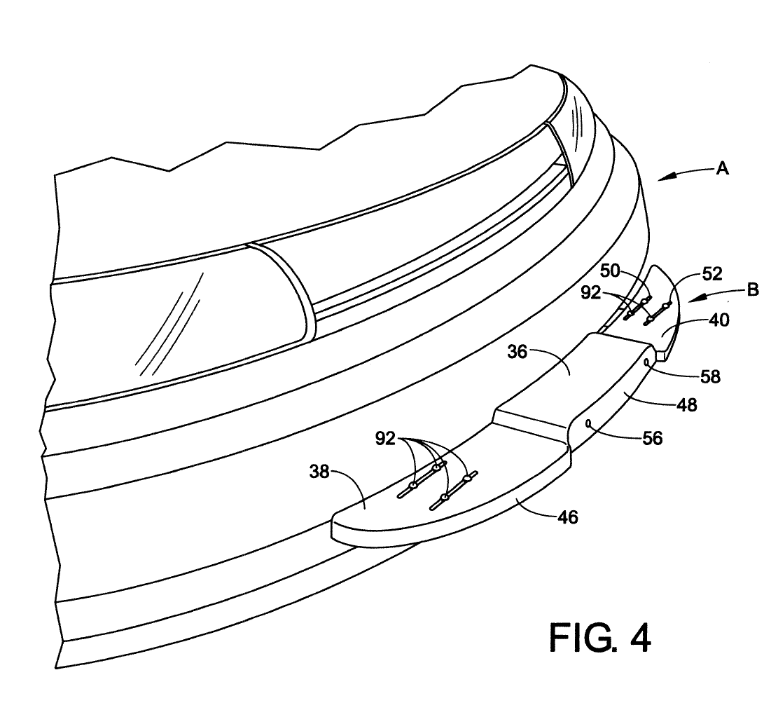

When fully installed, the arcuate or otherwise convexly curved shape of end areas or wings 38, 40 prevent injury to anyone who may accidentally bump into the grill area of the vehicle. Flange 46 helps conceal the prong connectors or receivers 32, 34 from view while enhancing the overall aesthetic appearance. Raised central area 36 of panel or body 30 covers and conceals cylinder 22 and air supply fitting 24. Spaced openings 56, 58 in wall or flange 48 provide means for attaching a front license or other plate (not shown) against wall 48. When it is desired to tow automobile A, it is simply necessary to remove unit B from its mounted relationship as shown in FIG. 4 to expose tow bar connecting assembly 10 as shown in FIG. 1 for connection in a known manner to the tow bar connecting assembly on an associated camper vehicle. Unit B can then be conveniently stored until it is again required for use.

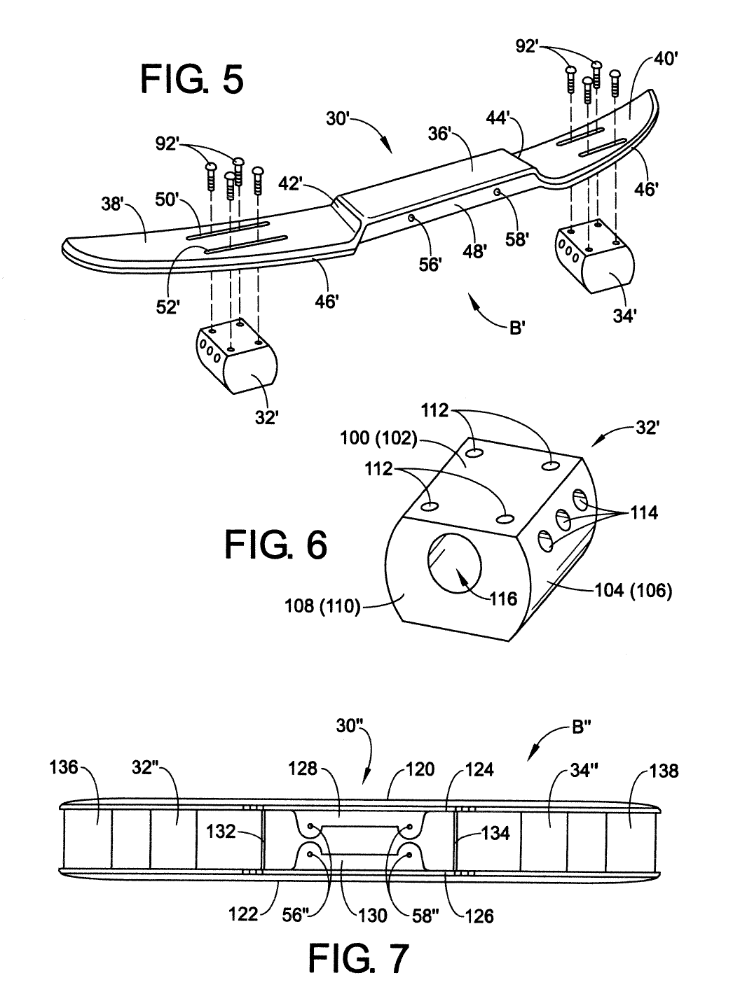

FIGS. 5 and 6 show a modified version of the subject protective and decorative faux vehicle bumper component. For ease of appreciating and understanding this alternative, like components are identified by like numerals with a primed (′) suffix and new components are identified with new numerals. FIG. 5 in particular shows receiver 32′ as having opposed top and bottom faces 100, 102, opposed side faces 104, 106, and opposed rear and front faces 108, 110. While side faces 104, 106 are shown as being somewhat outwardly convex, it will be appreciated that other conformations for all the various faces may be varied as necessary and/or desirable for manufacturing or product utility purposes. Receivers 32′, 34′ may also be molded from a plastic material or resin material as necessary and desired to achieve the necessary strength and flexibility. In some cases, it may be desirable to have the internal portion of the receivers constructed from an impact absorbent material. Such design and manufacturing modifications will be mandated by the specific application intended for the faux vehicle grill component B′.

A series of openings 112 penetrate receiver 32′ from top surface 100 and are used to adjustably secure the receiver to flat panel or body 30′ at end area or wing 38′ by means of conventional threaded fasteners or the like 92′. A series of locking pin receiving openings 114 extend through the receiver between side walls 104, 106. These openings are used to fixedly secure unit B′ to an associated tow bar connecting assembly in a manner to be described. A larger opening or bore 116 extends inwardly into receiver 32′ from rear face 108 toward front face 110. While this opening is shown as being generally circular in cross section, it is dimensioned and configured to conform generally to and receive an associated spike or prong 14, 16 when the unit B′ is installed on an automobile. Openings 114 communicate transversely through opening or bore 116 in order to adjustably receive a locking pin therethrough when unit B′ is installed.

Referring to both of FIGS. 5 and 6, component B′ is again adapted to fit over and conceal the outwardly protruding portions of a tow bar connecting assembly in the same manner as previously described. To that end, retainers or threaded fasteners 92′ are employed to connect prong receivers 32′, 34′ to ends or wings 38′, 40′, respectively, of generally flat body 30′. These fasteners pass through slots or openings 50′, 52′ of body 30′ and into openings 112 in top walls 100 of the prong receivers (FIG. 6) to thereby assemble these components together into a single unit. The prong receivers may be moved laterally toward and away from each to accommodate the lateral spacing between the spikes or prongs 14, 16 of the tow bar assembly.

Once the prong receivers are appropriately spaced and securely fastened to flat panel or body 30′ by tightening fasteners 92′, unit B′ is ready for installation on an associated automobile. This is accomplished simply by sliding the unit onto the outwardly protruding prongs (14, 16 in FIG. 1) in the same advantageous manner previously described. Unit B′ is retained in position by conventional locking pins or the like (not shown) which are inserted through an appropriate one of openings 114 in the side walls of prong receivers 32′, 34′. These fasteners also pass through pin receiving openings (20 in FIG. 1). The plurality of openings 114 thus accommodate some forward and aft adjustment of unit B′ relative to an associated tow bar connecting assembly.

FIG. 7 shows another modified version of the subject protective and decorative faux vehicle bumper component. There, for ease of appreciating and understanding this alternative, like components are identified by like numerals with a double primed (″) suffix and new components are identified with new numerals. Unit B″ is comprised of first upper and second lower panels 120, 122 which have peripheral conformations similar to the arrangement of the preferred embodiment as shown in FIG. 2. These panels have downwardly and upwardly disposed flanges 124, 126, respectively, along the peripheral edges thereof as shown in the drawing. Flange extensions 128, 130 extend from flanges 124, 126, respectively, and include holes or openings 56″, 58″ to accommodate affixation of a license plate and/or a frame for retaining a license plate.

Spacing and stabilizing fins 132, 134 are affixed to and extend laterally between panels 120, 122. Curved/arcuate spacing and stabilizing fins 136, 138 extend between the panels adjacent the outboard ends thereof, and prong receivers 32″, 34″ are likewise interposed between panels 120, 122 intermediate fins 132, 136 and 134, 138, respectively. As with the preferred embodiment, the receivers are adjustable laterally of each other along upper and lower panels 120, 122. This alternative arrangement provides a strong reinforced construction and functions in the same manner as described above relative to the preferred embodiment. The various components of unit B″ can be molded from a plastic or other suitable resinous material and then fabricated into a single unit by conventional means which themselves do not form a part of the present development.

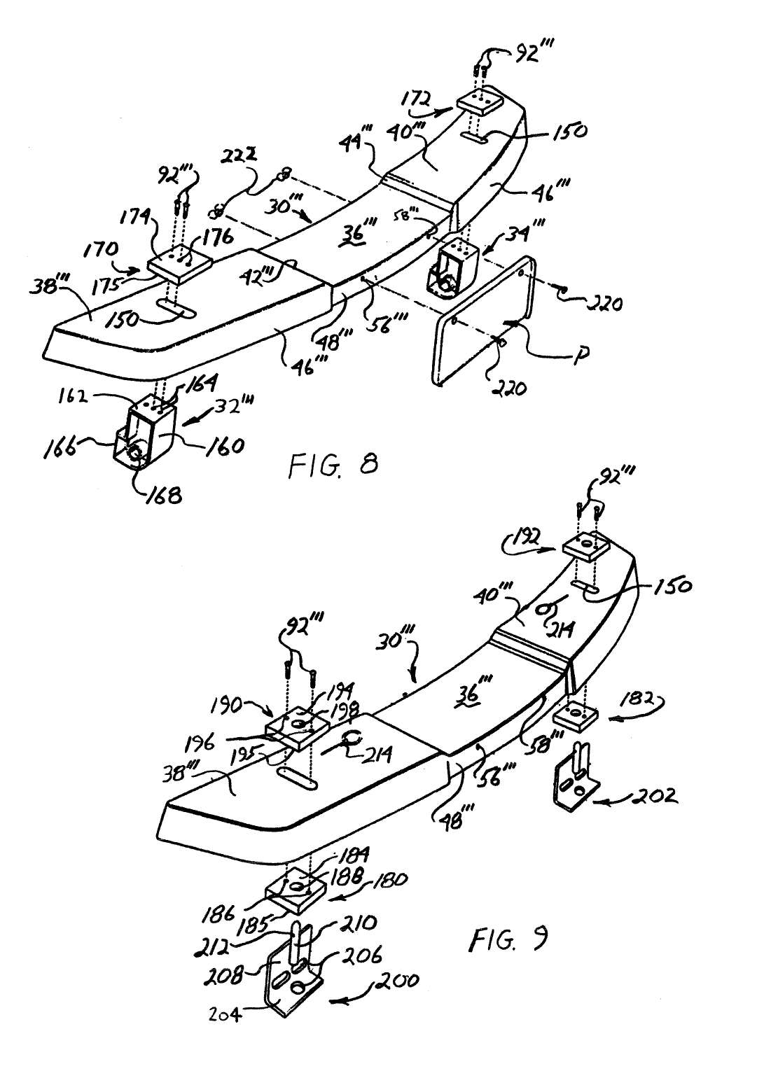

FIGS. 8 and 9 show additional modified versions of the subject new protective and decorative faux vehicle bumper component. For ease of appreciating and understanding these alternatives, like components are identified by like numerals with a triple primed (″′) suffix and new components are identified by new numerals. These particular alternatives are particularly adapted to use in a manner similar to the arrangement shown in FIGS. 1-4 where another type of known tow bar assembly is employed. In these arrangements, the prongs or spikes that protrude outwardly from the vehicle to be towed are such that they are disposed at predetermined laterally spaced apart distances regardless of the style or type of vehicle involved. Thus, virtually no significant accommodation for lateral adjustment is required for the tow bar mounting points in the faux bumper component. This different type of tow bar assembly is, again, known in the art and does not itself form a part of the present development.

In the FIGS. 8 and 9 arrangements, laterally spaced apart elongated slots 150, 152 are included in panel body ends or wings 38″′, 40″′, respectively, to extend transversely of the longitudinal axis of the flat panel or body 30″′. This, again, is due to the fact that the prongs of the associated tow bar assembly are disposed at a predetermined constant distance apart from each other regardless of the type of vehicle involved. However, the arrangements of FIGS. 8 and 9 do facilitate some front to back adjustment of the faux bumper component relative to an associated vehicle.

Referring specifically to FIG. 8, a pair of prong or yoke receiver assemblies 32″′, 34″′ are identical, so description will hereinafter be made with reference to assembly 32″′, it being appreciated that it is equally applicable to assembly 34″′. Assembly 32″′ is comprised of a somewhat J shaped receiver body 160 having a planar first or mounting surface 162 at a top or upper end thereof. Receiver body 160 is preferably constructed or molded from a plastic or other material which has suitable strength and rigidity to retain the faux bumper in a securely mounted position on an associated vehicle. A plurality of aligned threaded fastener receiving openings 164 penetrate surface 162 to facilitate secure attachment of the receiver assembly to flat panel or body 30″′ at end or wing 38″′ through slot 150 via threaded fasteners 92″′. The spacing of these fastener receiving openings and the length of slot 150 are such that they will allow for some forward and rearward adjustment of the faux bumper component relative to an associated vehicle.

The lower end of receiver body 160 defines a second or receiver end 166 adapted to receivingly communicate with a mounting clevis or yoke (not shown in FIG. 8) from a spike or prong of an associated tow bar connecting assembly. This type of associated tow bar assembly, itself, is already known in the art and does not form a part of the present development. A through opening or bore 168 adjacent receiver end 166 of body 160 allows for selective convenient and secure interconnection between the spike or prong and the faux bumper via a locking pin (not shown) in much the same manner as previously described with reference to the FIGS. 2-4 structure.

Top plates or caps 170, 172 are provided for cooperation with prong or yoke receiver assemblies 32″′, 34″′ at panel ends or wings 38″′, 40″′, respectfully. Plates 170, 172 are preferably constructed or molded from a plastic or other material which has suitable strength and rigidity to retain the faux grill in a securely mounted position on an associated vehicle. Since these top plates are identical, description will only be made with reference to plate 170. This plate is generally square or rectangular in conformation with planar top and bottom surfaces 174, 175. A plurality of fastener clearance openings 176 extend through the top plate between planar top and bottom surfaces 174, 175 at spaced intervals thereacross. The spacing between openings 176 corresponds to the spacing between fastener receiving openings 164 in receiver body 160 and readily accept passage of threaded fasteners 92″′ therethrough for assembly of the faux bumper.

Assembly of the faux bumper requires that the shanks of conventional threaded fasteners 92″′ pass through top plates or caps 170, 172 from top surfaces 174, through slots 150 in ends or wings 38″′, 40″′ of body 30″′, and then into threaded engagement with fastener receiving openings 164 of receiver bodies 160, 162. Tightening of fasteners 92″′ then brings the opposed bottom faces 175 of top plates or caps 170, 172 and top faces 162 of receiver bodies 160, respectively, into close retaining engagement with opposite face surfaces of ends or wings 38″′, 40″′. The opposed faces 175 of top plates or caps 170, 172 and faces 162 of receiver bodies 160 provide solid support for flat panel or body 30″′ to enhance the strength and rigidity of the overall faux bumper assembly. Slots 150 allow for some forward and rearward adjustment of receiver assemblies 32″′, 34″′ relative to flat panel or body 30″′ to facilitate use with different types of vehicle designs while maintaining a substantially fixed distance between receiver assemblies 32″′, 34″′.

The construction shown in FIG. 9 is to accommodate yet another type of known tow bar assembly. In this alternative, a pair of intermediate, square or rectangular adaptor or mounting plates generally designated 180, 182 are provided. These plates preferably are constructed or molded from a plastic material which has suitable strength and rigidity for faux bumper mounting purposes, although other materials could also be satisfactorily used. As the adaptor plates are identical, description will hereinafter only be made with reference to plate 180. This plate includes a planar first or top surface 184 and a planar second or bottom surface 185. A plurality of spaced apart aligned threaded fastener receiving openings 186 extend into top surface 184 toward bottom surface 185.

A through bore or opening 188 is generally centrally located in planar face 184 for use in mounting the faux bumper component to an associated vehicle in a manner to be described. This through bore or opening 188 is aligned with fastener receiving openings 186 so, in turn, to align with elongated slot 150 when adaptor or mounting plate 180 is fixedly secured to panel or body 30″′. The diameter of bore or opening 188 is preferably greater than the diameters of threaded fastener receiving openings 186 for stability reasons which should become apparent below.

This alternative arrangement also uses a pair of top plates or caps 190, 192 for cooperation with mounting plates 180, 182, respectively. These plates 190, 192 are likewise constructed or molded from a plastic or other material which has a suitable strength and rigidity for their purpose. Here, too, the plates or caps 190, 192 are identical, so description will be hereinafter made only to plate or cap 190. This plate or cap is generally square or rectangular in conformation similar to plate 180 with planar top and bottom surfaces 194, 195. A plurality of fastener clearance openings 196 extend through the top plate from top surface 194 at spaced intervals which correspond to fastener receiving openings 186 in mounting plate 180 and which allow passage of threaded fasteners 92″′ therethrough for assembly of the faux bumper component. A through bore or opening 198 having the same diameter as bore 188 is generally centrally located in planar face 194 for use in mounting the faux bumper component to an associated vehicle in a manner to be described. This bore is located to align with bore 188 in mounting plate 180, likewise for use in mounting the faux bumper.

Assembly of the faux bumper of FIG. 9 again requires that the shanks of conventional threaded fasteners 92″′ pass through top plates or caps 190, 192 from top surfaces 194, through slots 150 in ends or wings 38″′, 40″′, and then into threaded engagement with fastener receiving openings 186 in mounting plates 180, 182, respectively. Tightening of fasteners 92″′ then brings the opposed faces of top plates or caps 190, 192 and mounting plates 180, 182 into close retaining engagement with opposite face surfaces of ends or wings 38″′, 40″′, respectively. Through bores or openings 188 and 198 will then be aligned with each other to accept a mounting prong of a known type from the tow bar assembly in a manner to be described.

The FIG. 9 construction has been developed for use with a particular known type of tow bar assembly (not shown) including a pair of generally L shaped tow bar brackets 200, 202. These brackets are not themselves part of the present development and are included simply for allowing a better appreciation of the development. Since brackets 200, 202 are identical, description will hereinafter only be made to bracket 200. This mounting bracket includes a lower leg or base 204 having a plurality of slots and/or openings 206 passing therethrough for use in securely mounting the bracket to an associated tow bar assembly in an already known manner. An upright leg 208 extends from one end of base 204 and has a generally cylindrical locating and mounting prong 210 protruding outwardly from the free terminal end thereof. A cross drilled hole 212 extends through prong 210 intermediate the outer free end of leg 208 and the outer terminal end of prong 210. Hole 212 is adapted to receive a linchpin 214 or similar type of locking device for retaining the faux bumper component in a secure position on a tow bar assembly.

When assembled as described above and placed on an associated tow bar assembly, the lower or bottom surfaces 185 of adaptor or mounting plates 180, 182 rest upon the top surfaces of legs 208 of tow bar brackets 200, 202 with pins or prongs 210 of tow bar brackets 200, 202 protruding through bores or openings 188 of mounting plates 180, 182, through slots 150, and then through bores or openings 198 of top plates or caps 190, 192. It will be appreciated that the thickness dimensions of mounting plates 180, 182, panel body opposed ends 38″′, 40″′, and cap or top plates 190, 192 are predetermined so that when the faux grill component is positioned on tow bar mounting brackets 200, 202, pin openings 212 will be located immediately above and closely spaced to top surfaces 194 of the top plates or caps 190, 192. This ensures that linchpins 214 or other locking pins inserted through cross openings 212 in mounting pins or prongs 210 of mounting brackets 200, 202 will closely retain the faux bumper in the desired protective position on the associated tow bar assembly. Some forward and rearward adjustment of the faux bumper is easily effected simply by loosening or positioning fasteners 92″′ to allow sliding adjustment of the faux bumper via slots 150 in much the same manner as in the FIG. 8 construction.

Both arrangements as shown in FIGS. 8 and 9 include the capability for accommodating a license or other name plate in a manner similar to the FIGS. 2-4 embodiment. Particularly referring to FIG. 8, spaced apart through openings 56″′, 58″′ in panel flange area 48″′ are placed to receive threaded fasteners 220 therethrough for affixing a standard license or other name plate P to the front of the flange. Wing type or other conventional nuts 222 received on the fasteners fixedly secure plate P in position and facilitate ease of removal or change.

The development has been described with reference to the preferred and alternative embodiments. Modifications and alterations will occur to others upon a reading and understanding of this specification. It is intended to include all such modifications and alterations insofar as they come within the scope of the appended claims or the equivalents thereof.

Having thus described the development, it is now claimed:

1. A protective and decorative faux bumper component adapted for selective installation on a tow bar connecting assembly of the type having a pair of outwardly protruding laterally spaced apart connecting prongs, said bumper component comprising: an elongated main panel having opposed end sections extending generally outward from a panel center section; a prong connector secured to each of said panel end sections and having a prong receiver at an area thereof; axes of said prong receivers being disposed generally parallel to each other and generally transverse to a longitudinal axis of said main panel extending between said opposed end sections; and, said prong receivers adapted to retainingly communicate with the connecting prongs of an associated tow bar connecting assembly.

2. The bumper component as defined in claim 1 further including first releasable retainers for securing said prong connectors to said opposed end sections while allowing selective adjustment of at least one of the transverse distance between said prong connectors along said main panel and the lateral distance between said prong connectors and said main panel longitudinal axis.

3. The bumper component as defined in claim 2 wherein said first releasable retainers facilitate selective adjustment of said transverse distance and further including second releasable retainers for allowing selective adjustment of said lateral distance.

4. The bumper component as defined in claim 2 wherein said first releasable retainers facilitate selective adjustment of said lateral distance.

5. The bumper component as defined in claim 1 wherein each of said opposed end sections includes at least one elongated through slot extending therethrough in operative communication with said prong connectors for allowing selective adjustment of the secured position of said prong connectors to said main panel.

6. The bumper component as defined in claim 5 including first retainers communicating between said panel end sections and prong connectors through said slots for securing said prong connectors to said main panel.

7. The bumper component as defined in claim 6 including a pair of laterally spaced apart elongated through slots in each of said opposed end sections.

8. The bumper component as defined in claim 1 wherein each of said prong connectors is comprised of a base portion and an adaptor which includes said prong receiver, said base portion being shiftably secured to said main panel by first retainers.

9. The bumper component as defined in claim 8 wherein said adaptors are selectively releasably secured to their associated base portions by second retainers for accommodating selective shifting of said adaptors relative to said base portions in a direction transverse to said main panel longitudinal axis.

10. The bumper component as defined in claim 1 wherein each said prong receiver includes a connector area adapted for secure connection to a connecting prong of an associated tow bar connecting assembly, said connector area having a connector pin receiving opening adapted for receiving a prong connecting pin therethrough.

11. The bumper component as defined in claim 10 wherein each connector area comprises an outwardly extending tang portion with said connector pin receiving opening extending laterally therethrough.

12. The bumper component as defined in claim 10 wherein each connector area comprises a bore penetrating into a receiver rear area with said connector pin receiving opening extending laterally through said bore.

13. The bumper component as defined in claim 1 where each of said opposed end sections includes at least one elongated slot extending transversely of said panel longitudinal axis.

14. The bumper component as defined in claim 13 including first releasable retainers communicating through said slots between said main panel end sections and said prong connectors for securing said prong connectors to said main panel.

15. The bumper component as defined in claim 14 further including top plates disposed on an opposite face of said main panel from said prong connectors, said main panel being retainingly engaged between said top plates and prong connectors by said first releasable retainers.

16. The bumper component as defined in claim 14 wherein each of said prong connectors comprises an adaptor plate including said prong receiver shiftably secured to said main panel by said first releasable retainers.

17. The bumper component as defined in claim 16 wherein said prong receivers comprise a first connecting opening through each said adaptor plate dimensioned for receiving a connecting prong of an associated tow bar connecting assembly therethrough.

18. The bumper component as defined in claim 17 further including top plates disposed on an opposite face of said main panel from said adaptor plates with said top plates each including a second connecting opening therethrough, said main panel being retainingly engaged between said top plates and adaptor plates by said first releasable retainers so that said first and second connecting openings are aligned with each other.

19. A protective and decorative faux bumper component for selective connection to a tow bar connecting assembly having a pair of outwardly protruding connecting prongs, said bumper component comprising: an elongated main panel having a longitudinal axis extending between opposed panel ends disposed outwardly of a panel center section; at least one elongated through slot in each of said panel opposed ends; a prong connector secured to said main panel through said at least one slot at each of said panel ends; a prong receiver included in each said prong connector, said prong receivers having axes disposed generally parallel to each other and generally transverse to said main panel longitudinal axis; and, first retainers for securing said prong connectors to said main panel through said slots and allowing selective adjustment of one of the transverse distance between said prong connectors and the lateral distance between said prong connectors and said main panel longitudinal axis.

20. The bumper component as defined in claim 19 wherein each prong receiver includes a connector area adapted for connection to a connecting prong of an associated tow bar connecting assembly, said connector area having a connector pin receiving opening adapted for receiving a prong connecting pin therethrough.

21. The bumper component as defined in claim 20 wherein each said connector area comprises an outwardly extending tang portion with said connector pin receiving opening extending laterally therethrough.

22. The bumper component as defined in claim 20 wherein each said connector area comprises a bore penetrating into a rear area of the receiver with said connector pin receiving opening extending laterally through said bore.

23. The bumper component as defined in claim 22 including a plurality of said pin receiving openings penetrating said bores at spaced intervals therealong.

24. The bumper component as defined in claim 19 wherein said at least one slot in each of said panel opposed ends extend parallel to said longitudinal axis and said first retainers allow selective adjustment of said transverse distance.

25. The bumper component as defined in claim 19 wherein each of said prong connectors is comprised of a base portion and an adaptor, said base portion being shiftably secured to said panel by said first retainers with said adaptor including said prong receiver.

26. The bumper component as defined in claim 25 further including second retainers for releasably securing said adaptors to said base portions and allowing for selective shifting of said lateral distance.

27. The bumper component as defined in claim 19 wherein said at least one slot in each of said panel opposed ends extends transversely of said longitudinal axis.

28. The bumper component as defined in claim 27 further including a stop plate disposed on an opposite face of said main panel from each of said prong connectors, said main panel being retainingly interposed between said top plates and prong connectors by said first releasable retainers.

29. The bumper component as defined in claim 27 wherein each of said prong connectors comprises an adaptor plate including said prong receiver shiftably secured to said main panel by said first releasable retainers.

30. The bumper component as defined in claim 29 wherein said prong receivers comprise a first connecting opening extending through each said adaptor plate dimensioned for receiving a connecting prong of an associated tow bar connecting assembly therethrough.

31. The bumper component as defined in claim 30 further including top plates disposed on an opposite face of said main panel from said prong connectors, said main panel being retainingly interposed between said top plates and prong connectors by said first releasable retainers, said top plates each including a second connecting opening therethrough aligned with said first connecting openings for receiving a connecting prong of an associated tow bar connecting assembly therethrough.

32. The bumper component as defined in claim 19 wherein said main panel includes a forward edge with a flange area depending therefrom between the outer terminal ends of said panel opposed ends.

33. The bumper component as defined in claim 32 including a license plate mounting assembly disposed in said flange area at said panel center section.

34. A protective bumper device comprising:
first and second connectors adapted for respective releasable engagement with first and second protruding prongs of an associated vehicle tow bar connecting assembly;
a body connected to and extending between the first and second connectors, said body adapted to cover at least part of the first and second prongs with which the first and second connectors are engaged.

35. The protective bumper device as set forth in claim 34, wherein said first and second connectors are adapted to be received in and/or on said respective first and second prongs of the associated vehicle tow bar assembly.

36. The protective bumper device as set forth in claim 35, wherein the first and second connectors each comprise at least one opening adapted to receive an associated locking pin for releasable securement of the first and second connectors to the associated first and second prongs, respectively.
